(19) United States
(12) Patent Application Publication
(10) Pub. No.: US 2024/0289723 A1
(43) Pub. Date: Aug. 29, 2024

(54) A System and Method for Registering the Use of an Activity Area

(71) Applicant: Count4Care ApS, Solrød Strand (DK)

(72) Inventors: Carsten JØRGENSEN, Køge (DK); Lars PEHRSON, Brondby Strand (DK)

(21) Appl. No.: 18/569,816

(22) PCT Filed: Jun. 13, 2022
(86) PCT No.: PCT/EP2022/066025

§ 371 Date: Dec. 13, 2023

(30) Foreign Application Priority Data
Jun. 14, 2021 (EP) 21179262.7

(51) Int. Cl. G06Q 10/0639

(52) U.S. Cl. CPC G06Q 10/0639

(57) ABSTRACT

The system for validating the use of an activity area comprises an activity area having at least one activity detector adapted for collecting activity data. A computer is configured for determining, based on the activity data, an activity level in one or more zones in said activity area, comparing the activity level in said one or more zones onto a known mapping of said activity area, and determining whether the activity level in said one of more zones is above a predetermined activity value based on said known mapping.

### CROSS-REFERENCE TO RELATED APPLICATIONS

This application is the national phase of, and claims priority to, International Application No. PCT/EP2022/066025, filed Jun. 13, 2022, which claims priority to European Patent Application No. 21179262.7, filed Jun. 14, 2021.

### FIELD OF THE INVENTION

The invention relates to a method and a system for registering the use of activity items of an activity area, such as but not limited to children's playgrounds.

### BACKGROUND

Activity areas such as children's playgrounds comprise expensive furniture, such as swings, roundabouts, slides, climbing frames, sandboxes, see-saws etc. The furniture is arranged with proper spacing between them to ensure safety. Often there will also be benches for the accompanying parents looking after their children.

Playground furniture is often subject to harsh treatment when used by children and therefore subject to wear and tear, and breakdown. Acts of vandalism are also known to occur. This means that a playground must be monitored and repaired in order to keep the playground in good and safe condition. Traditionally, this monitoring is performed by manual inspection by a janitor, a groundskeeper or the like, who also ensures that repair and maintenance is performed. This is costly, cumbersome, and therefore not performed at intervals, because constant monitoring is not possible. It may also happen that inspection of specific pieces of playground furniture is overlooked, forgotten or recorded wrongly. In this respect, DE10252164 suggests building a transponder into each piece of playground furniture to verify and record the inspection. This however still requires an inspector present at regular intervals, and thus incurs costs.

Along the same lines FR2902554 discloses a modular management system for a recreational area. The system deals with centralising the information gathered and making it available for the involved parties in order to efficiently coordinate the management of the recreational area. There are no details given about the gathering of data as such. When establishing a playground, the choice of furniture and the overall layout of the playground is typically done by an experienced professional with knowledge of the targeted age group, within the constraints of physical area and economical budget available. Being based on experience, the layout may therefore be strongly subject to the feelings, and personal ideas of the person or group, designing the playground. Lack of experience, subjective ideas or anecdotal evidence of how to design a playground may accordingly lead to a sub-optimal layout, where certain pieces of furniture are underutilized. Underutilization could also happen if the playground is a public playground, and there is a lack of demographic basis, i.e. children in the targeted age group.

Furthermore, it is well known that there is a link between children's physical activity and their learning abilities. Thus, if a school's playground is extensively used it is an indicator that during classes the learning abilities of the school children are also high. If the playground or parts thereof is underutilized, it may therefore be relevant to reconsider the layout of the playground in order to improve learning abilities.

### SUMMARY

Based on this, it is an object of the invention to provide a method and a system for registering the use of activity items of an activity area, such as a children's playground, thereby also allowing the verification of the use and layout.

According to a first aspect of the invention, this object is achieved by a method of registering the use of activity items of an activity area, said method comprising the steps of: providing an activity area comprising a number of activity items, providing at least one digital computer having digital storage, mapping said activity area so as to provide a grid with a number of meshes identifying the location of each activity item, and storing information defining said grid in the digital storage, defining an activity reference level for each of said meshes based on the type of activity item located in the meshes and storing information regarding said activity reference level in the digital storage, providing at said activity area at least one activity detector, collecting activity data using said at least one detector, determining, based on the collected activity data, an activity level in the meshes of said grid, using said digital computer, comparing the determined activity level in said meshes with the activity reference levels in said meshes stored in the digital storage, and determining whether the activity level for each activity item is within a predetermined range based on the activity reference level for that specific activity item.

With this method, objective data reflecting the actual use of the activity area can be gained and registered. This, in turn, provides verified knowledge on whether parts of the activity area are underutilized or possibly not used at all. Such knowledge can then be used to redesign the activity area for better utilization, or in the long term, when sufficient knowledge has been gained from multiple activity areas, lead to better design of activity areas. Such better layouts will reduce costs because in the long run less unused activity items, such as playground furniture, will be installed, and less ground space will be left unused in cities. It also opens the possibility of discovering defective activity items and hence immediate maintenance.

According to a second aspect of the invention, a system for registering the use of activity items of an activity area includes: an activity area comprising a number of activity items, at least one digital computer having digital storage, where said digital storage stores a mapping of said activity area defining a grid with a number of meshes identifying the location of each activity item, and an activity reference level for each of said meshes based on the type of activity item located in the meshes and storing information regarding said activity reference level in the digital storage, at least one activity detector adapted for collecting activity data, said digital computer being configured for determining, based on the collected activity data, an activity level in the meshes of said grid, comparing the determined activity level in said meshes with the activity reference levels in said meshes stored in the digital storage, determining whether the activity level for each activity item is within a predetermined range based on the activity reference level for that specific activity item.

According to a preferred embodiment of the invention, the step of determining whether the activity level for each activity item is within a predetermined range based on the activity reference level for that specific activity item is performed in at least one predetermined time window. Hereby, it becomes possible to link the activity to certain time periods. For instance, link the activity of school children during recess to subsequent time classes. It may also be possible to monitor the use of an activity area throughout the day, to verify when which parts of an activity is used and whether some are underutilized. It may also be possible to detect undesired utilization, e.g. at night time.

According to another preferred embodiment, a warning is given if, for one or more of said activity items, activity is outside said predetermined range. This warning could then prompt systematic consideration of the design based on all data collected in order to improve the activity area.

According to another embodiment, the warning is an underutilization alert given if the activity is below said predetermined range. This could be used to identify defective activity items, such as a broken swing or the like.

According to a further preferred embodiment, the underutilization alert is sent to a maintenance responsible authority. This may prompt a groundskeeper or janitor to check whether something is wrong with the furniture, e.g. a see-saw or a swing not being used due to a defect that needs to be repaired. This could trigger prompt repair and increase the utilization of the activity area.

According to a further embodiment of the invention, the digital computer is a remote server, and the steps of determining, based on the collected activity data, an activity level in the meshes of said grid, using said digital computer, comparing the determined activity level in said meshes with the activity reference levels in said meshes stored in the digital storage, determining whether the activity level for each activity item is within a predetermined range based on the activity reference level for that specific activity item, are performed on said remote server. The computer used as the server may then also be available for the analysis of the data, the display of results, the issuance of warnings, etc.

According to yet another preferred embodiment, the activity data is anonymized in the at least one activity detector. By anonymizing the activity data at the source, a high degree of data security may be achieved in terms of protection of personal information of those present in the activity area, and hence the acceptance among the users of the activity area.

According to a most preferred embodiment, the activity area is a children's playground. Children's playgrounds are considered the areas where the invention will yield most relevant information, as there are many of them, they are prone to hard use, and they are relevant for the wellbeing and learning abilities of children.

### BRIEF DESCRIPTION OF THE DRAWINGS

The invention is described in greater detail below, based on non-limiting exemplary embodiments and with reference to the drawings, in which:

FIG. 1 schematically shows system for verifying activity an activity area according to the invention,

FIG. 2 shows an activity detector and a computer forming part of the system according to the invention,

FIG. 3 shows steps of object detection and tracking,

FIG. 4 shows steps of statistical analysis of utilization, and

FIG. 5 schematically shows a 360° panoramic view from a camera with an overlaid grid.

### DETAILED DESCRIPTION

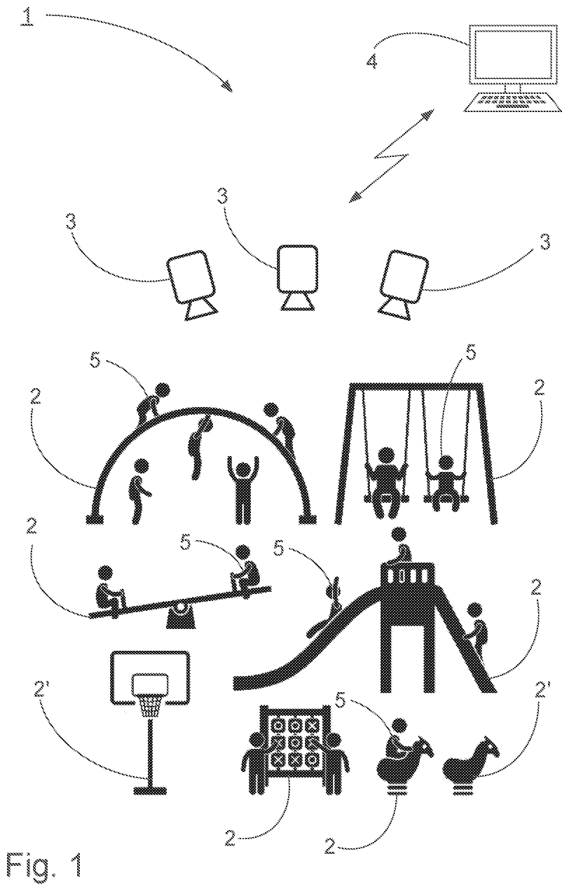

Turning first to FIG. 1 an activity area according to the invention is shown. The outset for the invention is as illustrated a children's playground, and for the convenience of explanation the following description will be given for a children's playground 1. However, the activity area can in principle be any kind of activity area, such as an area with outdoor exercise equipment, a swimming or bathing facility, a children's playground 1 or even combinations thereof. The activity area may also be indoors.

The playground 1 comprises a number of activity items, such as pieces of equipment or furniture, generally denoted with the reference numeral 2, but with the addition of a prime to distinguish unused furniture 2′. Playground furniture 2 comes in many variations, inter alia depending on the targeted age group, and may, as illustrated, include swings, slides, climbing frames, see-saws, basketball hoops, rocking horses, and game frames, as well as roundabouts, sandboxes etc. Activity items may also include benches for accompanying adults as well as voids deliberately left open for free play, as opposed to the spacing necessary to ensure safe distancing between the various pieces of furniture 2. Such voids may include areas with purpose selected surfaces or areas with markings painted on the ground, e.g. hopscotch grids, open spaces for rope skipping, lawns for ball play, etc. In principle the invention is applicable to just a single piece of furniture 2, but typically a playground would comprise several different pieces of furniture 2.

The playground 1 also comprises a number of suitably distributed and oriented activity detectors 3 to monitor the furniture 2 and, preferably, also the voids between them. Depending on e.g. the type of activity detector 3 and the layout of the playground 1 a single activity detector 3 may suffice.

The activity detectors 3 could include digital cameras for visible and/or infrared light, laser scanners, LiDAR scanners, range sensors, stereo cameras, structured light sensors, etc. as well as combinations thereof. The aforesaid optical activity detectors could also be supplemented with acoustic detectors.

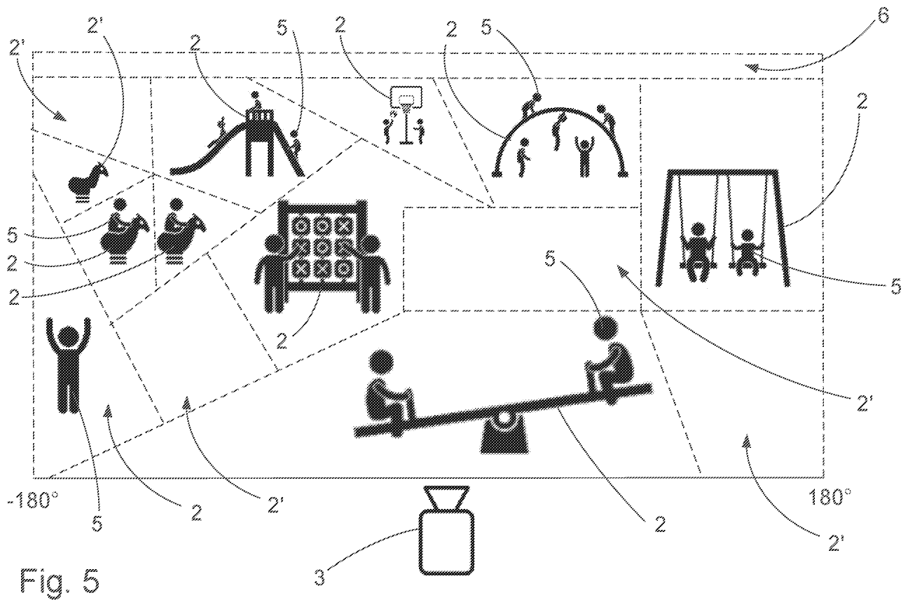

It is currently preferred to include cameras among the activity detectors 3. Cameras have the advantage that a visual representation of the playground may be presented to a human or an artificial intelligence (AI) observer, in order to define a grid indicating the location of the various activity items and zones around them, as well as areas or items of non-interest. FIG. 5 shows a schematic example of a 360° camera view of a children's playground. In this image the various activity items have been identified using a panoramic view of the playground 1, e.g. taken by one or more cameras arranged on a pole arranged somewhat centrally on the playground 1. Based on this a human or an AI has provided a grid (dashed lines) with meshes allowing the individual activity zone and the activity items therein to be stored for reference. As will be understood from FIG. 5, the meshes of the grid may be irregular shapes. Since even the movable activity items are generally stationary at a given location, this grid may be stored in a database on a digital storage device in or associated with a computer 4. Apart from areas of interest with activity items, grids defining areas or items of non-interest may also be identified. Such areas or items of non-interest could be buildings, roads, trees, the sky 6 etc. outside the playground 1, where activity such as moving cars, flying birds, falling leaves etc. is of no interest and would just disturb the registration of activity of interest. To these meshes in the grid an activity reference level may then be assigned, depending on the activity item withing the respective meshes, e.g. based on expected activity levels gained from earlier studies or prior use of the method at other locations. A known map of the playground with zones of activity and activity reference level is thus provided for later reference when registering actual activity.

The pole with the activity detectors is preferably a self-contained unit, in the sense that it has renewable power, such as from sun or wind, energy storage, communication facilities, computing power etc. allowing it simply to be erected in the most appropriate place on any activity area needed, without having to dig up the playground 1 for power supply communication or the like. It is thus also suitable for easy retrofitting on existing playgrounds 1, in turn allowing registration of the use thereof and determination of whether it is properly and efficiently utilized.

Currently, it is also preferred to include stereo cameras. Stereo cameras allow detection of persons 5 in the field of view as well as their number based on image recognition and the assessment of current position, velocity, and direction of motion in all three dimensions of each of the persons 5. This may be done using software adapted to recognize persons 5 and constructing simplified models, such as outlines or skeletons, i.e. stick figures. Preferably, the image recognition is adapted to continuously track the individual persons 5, not only during current presence in the field of view, but also to regain track even if a tracked person 5 moves out of the field of view and back in again.

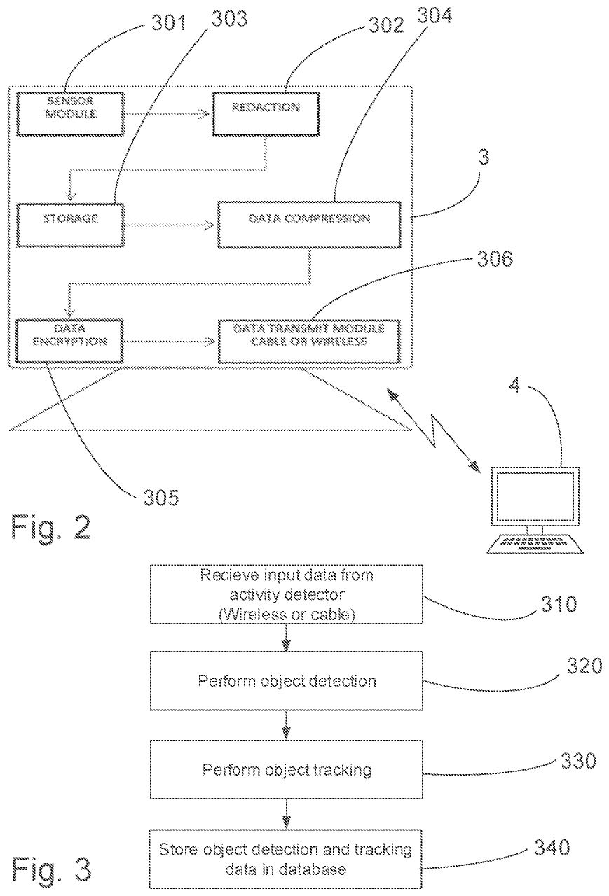

As an example, the activity detector 3 illustrated in FIG. 2 comprises a sensor module 301. The sensor module 301 could be an imaging chip adapted to capture physical input such as visible or infrared light and convert it into digital data that may be processed by a digital data processor. If the digital data processing of activity data includes image recognition as part of the activity detection algorithms or in other ways allow individual persons 5 to be recognized, the resulting data may be anonymized in a redaction module 302, in order to keep the individuals recognized as persons 5 performing activity anonymous. If outlines or skeletons are constructed in the motion detection, these may substitute the actual images, and thus provide the desired anonymity.

The anonymized data may be stored internally in a storage module 303 in the activity detector 3. The data may also be compressed in a data compression module 304 as well as encrypted in a data encryption module 305. Some of these steps and modules 302-305 may, depending on the nature of the sensor module 301 and on the output data from the sensor module 301, be unnecessary or optional, e.g. if persons or individuals cannot possibly be recognised anyway. Some of these modules 302, 304 and 305 may be implemented as software. Also, the sequence need not be as described, e.g. data compression could be made before the storage. The processed and preferably anonymized and encrypted data may then be transmitted to a remote computer 4 or server where it is stored, e.g. in a database, and may be used for further processing and analysis, such as statistical analysis of the detected activity, e.g. determination of activity levels in various zones, comparison of the zones of activity with a known map of the playground 1, i.e. the location of furniture 2 and voids between them, correlation of activity with predetermined time windows, etc. Activity levels could be considered in different ways, e.g. in terms of number of persons 5 in the zone, the individual movement of the persons 5 in the zone, the movement of movable furniture 2, such as see-saws, swings, rocking horses and roundabouts, as well as the sums and weighted averages of these movements.

In particular such analysis may be used to identify if there are zones of low activity, be it temporarily or permanently, e.g. by comparison to a predetermined threshold. A warning of low activity in certain zones could then be given in order to instigate further investigation of the cause. If the zone containing the rocking horse 2″ in FIG. 1 is suddenly permanently below a threshold, an alert could be given by the computer 4 to a groundskeeper or a janitor to check whether the rocking horse 2′ is out of order and, if so, take steps to have it repaired. The warning could also be an alert to further investigate the reasons and possibly reconsider the layout of the playground 1. In the illustrated example, it could be that the basketball hoop 2′ is not used because the age group for which the remainder of the furniture 2 is suited, or the children allowed access to the playground 1 are below the age of those interested in or physically capable of playing basketball. This means that the playground is at least partially underutilized.

An underutilized playground 1 at a school could potentially influence the learning abilities. It is well established that there is a link between children's physical activity and their learning ability. Getting a warning about this and reconsideration of the layout of the playground 1 may therefore lead to a better and more optimized playground 1 appealing to more activity, in turn, leading to better learning. This would then allow a school to document having awareness of and focus on learning environment.

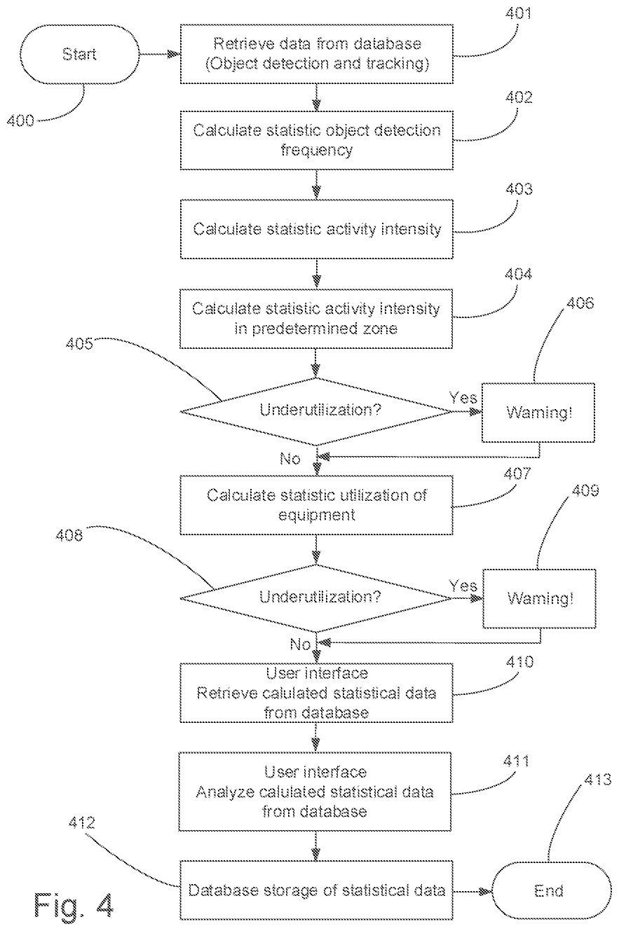

Turning now to FIGS. 3 and 4, examples of the data processing in the computer 4 that could be performed are described.

In FIG. 3 the computer 4 receives, in box 310, input data from the one or more activity detectors 3. In box 320 the computer performs object detection. How this object detection is performed depends on the input from the activity detectors 3. If for instance the sensor module 301 is an imaging chip, pattern recognition algorithms adapted to recognize objects, such as persons 5, may be applied. The persons 5 or other objects identified, may then, in box 330, be tracked for motion including amount and speed, etc. The results can then, in box 340, be stored in a database.

After starting the processing algorithms in box 400, data is, in box 401, retrieved from a database, e.g. that of box 340, or other storage of the data derived from the activity detectors 3. In box 402 a statistical object detection frequency may then be calculated, this could include number of persons 5 and/or other moving objects, such as moving furniture 2. The statistic object frequency calculation may include rate of motion based on motion detection so as to distinguish high intensity from low intensity not only based on number and density of persons 5, but also on the rate of movement, so as to calculate, in box 403, a statistic activity intensity. Statistic activity intensity may be defined and calculated in numerous ways based on various input parameters. This statistic activity intensity may then be compared to a predetermined activity reference level, threshold or range for the specific activity item or the mesh containing it, as identified previously by a human or artificial intelligence (AI). As indicated above, the number of identified persons 5 and their actual and relative locations are relevant parameters. Also, velocity of motion and direction of motion, in particular climb, are relevant intensity parameters. The statistic activity intensity may also include weighed averages over time. Furthermore, entirely different activity intensity indicators may be included, such as e.g. body temperature if infrared sensing or imaging is used. The statistic activity intensity may be used to calculate and identify, in box 404, the different statistic intensities in different zones, e.g. corresponding to a known map of the playground 1, such as where the different pieces of furniture 2, 2′ are located. If mapping of activity zones onto known information about the layout of the playground 1, as defined by the stored information about the grid, yields, in box 405, that at least during a predetermined period, such as recess, activity is below a given threshold for the zone, and hence the furniture 2′ is underutilized, a warning may be given in box 406. This warning could be an alert to a maintenance responsible authority, such as a groundskeeper or janitor to check whether the furniture 2′ is defective and needs repair. This allows efficient maintenance of the playground 1, without spending man-hours on active and mostly unnecessary routine checks. Other factors may also be used in determining underutilization, such as knowledge of the weather, and daylight hours, so as not to trigger any false warnings, just because the weather happens to be cold and rainy. Also, in box 407, it may be calculated whether parts of the playground 1 are not used as statistically expected, i.e. it may be checked whether certain areas of the playground 1 are not used as much as others, and underutilization may be established. If this is not caused by the furniture 2 being defective as would have been established in boxes 404-406, another kind of warning may be given off. Such another kind of warning could be a message or an alert indicating potential need to investigate more thoroughly the playing patterns of the children in the playground 1, be it by in-situ observation or review of stored data. The latter could be done using a suitable interface on the computer, allowing a user to retrieve calculated statistical data from the database, in box 410, for analysis in box 411, and final storage in box 412 if relevant. This subsequent analysis of the registered use of an activity item could then reveal whether parts of the playground 1 are not used for other reasons, such as being unsuitable for the age group allowed onto the playground 1 or that parts of the playground 1 feel less safe or secure. If so, steps may be taken to redesign at least these parts of the playground, to increase playing intensity in these areas, in turn, better utilizing the area, and allowing more room for play by lowering the high intensity in other places.

Another way of establishing an intensity value, would be to determine a first score A for an identified person's proximity to the activity item, e.g. by being in the same mesh of the grid. Several scores A may be accumulated if several persons are in the same mesh of the grid. For movable activity items, such as swings, see-saws, rocking horses etc. a further score B may be determined reflecting the coincidence of the movement of the person with the motion pattern of the activity item. This may be supplemented with a score C from a neural network trained to recognize specific motion patterns for persons in relation to certain activity items, be it playground furniture or activity patterns such as rope skipping, ball play, running or the like in grids without playground furniture. Based on this activity level of an identified person, as well as a correlation with the actual expected use of the activity item in that specific grid, i.e. the activity reference level, may be identified and registered.

As mentioned, it can also be envisaged that acoustic sensors are included. This could be used to listen to voices and screams, in turn allowing identification of age groups and possibly gender of the persons on the playground. This, in turn could aid in determination of whether the playground is laid out for the proper age group or if the gender distribution in use is balanced and reasonable.

With a system as described it becomes possible to monitor a playground for efficient play in terms of high intensity, to gain knowledge of the actual playing taking place and to use such knowledge to redesign an inefficient playground and design better future playgrounds 1. The skilled person will understand that without departing from the scope of the invention, the activity detectors 3 may be devised in numerous different ways depending on the detection technology used. Likewise, statistical analysis may be performed in numerous ways, depending on the knowledge sought to be derived in order to improve the playground 1 and the playing habits of the children.

1. A method of registering the use of activity items of an activity area, said method comprising the steps of:
a) providing an activity area comprising a number of activity items,
b) providing at least one digital computer having digital storage,
c) mapping said activity area so as to provide a grid with a number of meshes identifying a location of each activity item, and storing information defining said grid in the digital storage,
d) defining an activity reference level for each of said meshes based on the type of activity item located in the meshes and storing information regarding said activity reference level in the digital storage,
e) providing at said activity area at least one activity detector,
f) collecting activity data using said at least one detector,
g) determining, based on the collected activity data, an activity level in the meshes of said grid,
h) using said digital computer, comparing the determined activity level in said meshes with the activity reference levels in said meshes stored in the digital storage, and
i) determining whether the activity level for each activity item is within a predetermined range based on the activity reference level for that specific activity item.

2. The method according to claim 1, wherein the step i) is performed in at least one predetermined time window.

3. The method according to claim 2, wherein a warning is given if said activity level for one or more of said activity items is outside said predetermined range.

4. The method according to claim 3, wherein the warning is an underutilization alert given if the activity level is below said predetermined range.

5. The method according to claim 4, wherein the underutilization alert is sent to a maintenance responsible authority.

6. The method according to claim 1, wherein the digital computer is a remote server and wherein steps g), h), and i) are performed on said remote server.

7. The method according to claim 1, wherein, in the at least one activity detector, the activity data is anonymized.

8. The method according to claim 1, wherein the activity area is a children's playground.

9. A system for registering the use of activity items of an activity area, the system comprising:
an activity area comprising a number of activity items,
at least one digital computer having digital storage, wherein said digital storage stores a mapping of said activity area defining a grid with a number of meshes identifying the location of each activity item, and an activity reference level for each of said meshes based on the type of activity item located in the meshes and information regarding said activity reference level, and
at least one activity detector adapted for collecting activity data,
wherein said digital computer being is configured for:
determining, based on the collected activity data, an activity level in the meshes of said grid,
comparing the determined activity level in said meshes with the activity reference levels in said meshes stored in the digital storage, and
determining whether the activity level for each activity item is within a predetermined range based on the activity reference level for that specific activity item.

10. The system according to claim 9, wherein the digital computer is further configured to determine whether the activity level for each activity item is within a predetermined range based on the activity reference level for that specific activity item in at least one predetermined time window.

11. The system according to claim 9, wherein the digital computer is further configured to give a warning if, for one or more of said activity items, the activity level is outside said predetermined range.

12. The system according to claim 11, wherein the warning is an underutilization alert given if the activity level is below said predetermined range.

13. the system according to claim 12, wherein the computer is configured to send the underutilization alert to a maintenance responsible authority.

14. The system according to claim 9, wherein the computer is a remote server.

15. The system according to claim 9, wherein the at least one activity detector is configured for anonymizing the activity data.

16. The system according to claim 9, wherein the digital storage further comprises information regarding the at least one predetermined time window.

17. The system according to claim 9, wherein the activity area is a children's playground.
